(19) United States
(12) Patent Application Publication
(10) Pub. No.: US 2010/0058312 A1
(43) Pub. Date: Mar. 4, 2010

(54) Content Data Providing System, Content Providing Apparatus and Content Data Processing Terminal

(75) Inventor: Toshihiro Morohoshi, Kawasaki-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/533,686

(22) Filed: Jul. 31, 2009

(30) Foreign Application Priority Data
Jul. 31, 2008 (JP) 2008-198744

(51) Int. Cl. G06F 9/44

(52) U.S. Cl. 717/168; 726/2

(57) ABSTRACT

According to one embodiment, making an account management server manage also a user ID in the recording medium in a way, which transfers a firmware update toll of a set-top box (STB) terminal by using a recording medium such as a Secure Digital card as a medium, associates a medium and an account with each other. When loading the recording medium in the STB terminal, the STB terminal also associates an STB property with the account management server as account management data. Thereby, when loading a recording medium the next time, the update tool is automatically downloaded to the recording medium if a firmware function update tool is provided. If the recording medium is shared with a plurality of STB terminals, all of necessary firmware tools for the STB terminals are downloaded to the recording medium.

### CROSS-REFERENCE TO RELATED APPLICATIONS

This application is based upon and claims the benefit of priority from Japanese Patent Application No. 2008-198744, filed Jul. 31, 2008, the entire contents of which are incorporated herein by reference.

### BACKGROUND

1. Field

One embodiment of the Invention relates to a content data providing system, a content providing apparatus and a content data processing terminal which efficiently update firmware of a content data processing terminal such as a set-top box (STB).

2. Description of the Related Art

In recent years, as regards a distribution of content to an STB terminal, the content has been provided through a network distribution in addition to provision through a recording medium such as a CD. Meanwhile, in consideration of a case in which the distribution is not well adapted to a high-speed network environment for downloading the content, a retail store download selling system has been proposed. In the system, a user loads a recording medium such as a Secure Digital (SD) card in an interface unit of a communication terminal installed in a retail store, etc., accesses a content distribution apparatus through user authentication, and downloads to store arbitrary content in the recording medium. The user brings back the recording medium to load in the STB terminal, and reproduces the content stored on the recording medium by means of the STB terminal, or stores the content in a content storage unit in the STB terminal, and makes it possible to reproduce the content at any time.

The content data processing terminal such as the foregoing STB terminal is provided with a firmware update function of aiming to failure repair, change or addition of control processing, etc. The function is performed through obtaining an update tool provided for each product from a manufacturer and through execution of its program by means of the STB terminal. Usually, the tool is downloaded from the Web site of a manufacturer via the Internet, and installed in a firmware subject device through the recording medium to be executed (refer to Jpn. Pat. Appln. KOKAI Publication No. 2003-303028). However, it is necessary for the user to confirm, select and instruct a model number, a current firmware version, etc., of a product, and it is desired to enable confirming, selecting and instructing at ease.

As described above, the provision of the firmware update tool for the conventional content data processing terminal is performed in a procedure through which the tool is downloaded from the Web site of the manufacturer via the Internet, and the tool installed in the firmware subject device through the recording medium to execute the tool. However, it is necessary for the user to confirm, select and instruct the model number, the current firmware version, etc., of the product, and it is desired to enable confirming, selecting and instructing at ease.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a configuration of a content data providing system to which the invention is applied;

FIG. 2 is an exemplary flowchart depicting a processing procedure of an account management server shown in FIG. 1;

FIG. 3 is an exemplary flowchart depicting a processing procedure of firmware update of an STB terminal shown in FIG. 1;

FIG. 4 is an exemplary flowchart depicting a processing procedure of registering an STB property in the account management server at the STB terminal;

FIG. 5 is an exemplary flowchart depicting a processing procedure of an account management server in a case in which the STB terminal is unable to communicate with the account management server; and

FIG. 6 is an exemplary flowchart depicting a processing procedure of an STB terminal in a case in which the STB terminal is unable to communicate with the account management server.

### DETAILED DESCRIPTION

Various embodiments according to the invention will be described hereinafter with reference to the accompanying drawings. In general, according to one embodiment of the invention, there is provided a content data providing system comprising: a content data processing terminal configured to read content data from a recording medium with content recorded thereon, and appropriately reproduce the content data for viewing the content; and a content providing device configured to make a registered user of the content data processing terminal download arbitrary content to the recording medium, wherein the content providing device comprises: an account management unit which manages user account data of the content data processing terminal to perform authentication processing, and records a terminal property including product identification data of the content data processing terminal as related data of the user account data; a download management unit which provides content of which the download is required to the recording medium on the basis of an authentication processing result of the account management unit; a firmware management unit which manages an update tool of firmware of the content data processing terminal for each product; and an interface unit which receives operations of a user authentication request to the account management unit and a content download request to the download management unit in a loaded state of the recording medium, the account management unit determines whether the product identification data is included in the related data of the user account data if a user account has been obtained through the authentication processing from the recording medium, determines whether an update tool of firmware of the product is present from the firmware management unit if the product identification data is included, and downloads the firmware tool to the recording medium from the firmware management unit through the interface unit if the update tool is present, and the content data processing terminal determines whether the update tool has been recorded on the recording medium when the recording medium is loaded, and arbitrarily executes the update tool if the update tool has been recorded.

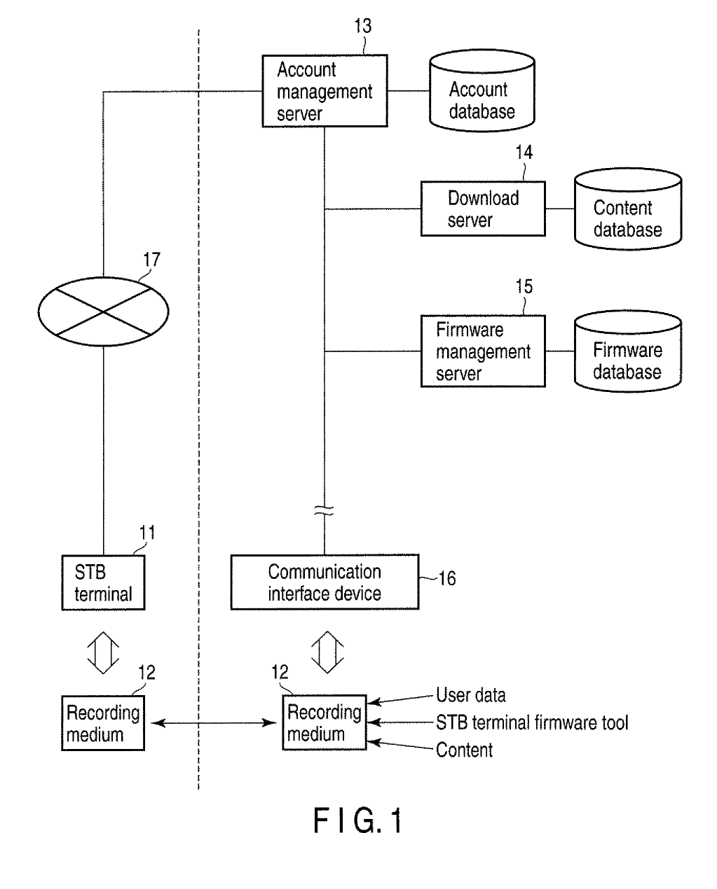

FIG. 1 shows a block diagram depicting a configuration of a content data providing system to which the invention is applied. In FIG. 1 when a recording medium 12 with content recorded thereon is loaded, an STB terminal reads content data recorded on the recording medium 12 to store it in a storage unit inside the STB terminal, and appropriately reproduces the content data to make it viewable. The STB terminal makes the loaded recording medium 12 record STB properties such as a manufacturing ID (which is corresponds to data such as a manufacturer origin, type, and makes it possible to distinguish a product name, a model number, serial number, etc.), and a firmware version.

Meanwhile, a content providing side is configured in a way in which an account management server 13 having an account database, a download server 14 having a content database, and a firmware management server 15 having a firmware database 15 are connected in a network manner, and further a communication interface device 16 is connected to the network. The interface device 16 receives input operations form a user in a state where the recording medium 12 has been loaded therein, and communicates with each server 13-15 in accordance with operation contents. The configuration on the content providing side is installed, for example, at a headquarters office of a company providing a service by using the foregoing content data providing system.

The account management server 13 makes it possible to register the STB properties as one item of user related data in the account database together with account management data of registered users. When the interface device 16 issues a user authentication request, the account management server 13 refers to the account database and compares and collates with user data to be provided by referring to the account database, and if they are coincide with each other, the account management server 13 allows the interface device 16 to be connected to the download server 14 and the firmware management server 15. The account management server 13 can communicate with the STB terminal 11 via a network 17 such as the Internet. It is assumed that the communication through this communication route is made at relatively slow rate, and that it is difficult to distribute content; however it is enough for the communication route to transmit the STB properties.

The download server 14 is, for example, a device which provides a service to be provided in the system and is installed at a store, etc. When receiving connection permission with the recording medium 12, the download server 14 reads specified content from the content database to supply the content to the recording medium 12 through the communication interface device 16. When receiving connection permission with the recording medium 12, the firmware management server 15 reads the STB properties recorded on the recording medium 12, and reads a firmware tool corresponding to the STB from the firmware database to supply the tool to the recording medium 12.

In the configuration given above, the flow of the operation will be described hereinafter.

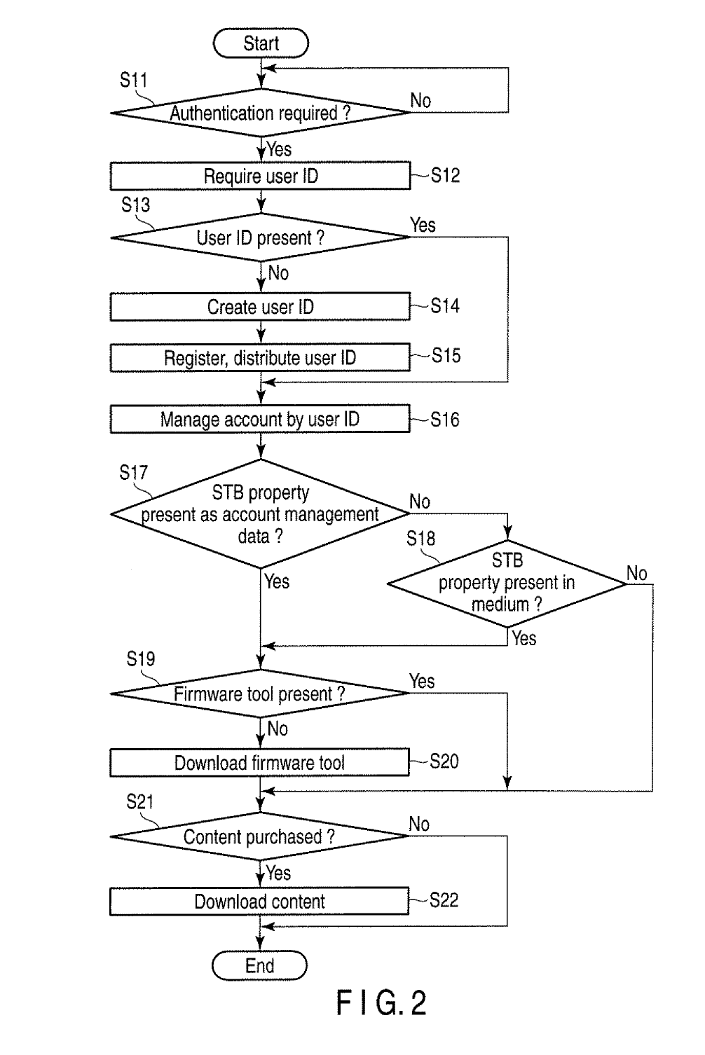

FIG. 2 shows a flowchart depicting a processing procedure in the account management server 13, when the recording medium 12 is loaded in the communication interface device 16. When a user operation from the interface device 16 issues an authentication request (Step S11), the account management server 13 starts account processing to require the user ID (Step S12), and determines the presence or absence of the user ID in accordance with the response (Step S13). If the user ID is not present, the management server 13 creates the user ID (Step S14), registers the user ID in the account database, and also distributes the user ID to the recording medium 12 (Step S15). When the management server 13 obtains the STB property upon presentation of the user ID through communicating with the STB terminal 11 via the network 17 as mentioned below, the management server 13 associates the STB property with the user ID to register the STB property in the account database.

If it is determined that the user ID is present in Step S3, or if the user ID is registered and distributed in Step S15, the management server 13 executes account management by means of the user ID (Step S16). The account management determines whether the STB property is present in the account database (Step S17), and if it is determined the absence thereof, the account management determines whether the STB property has been recorded in the recording medium 12 (Step S18).

If the STB property is obtained in Steps S17 and S18, the management server 13 determines whether the firmware tool, corresponding to the product ID (model), the firmware version, etc., shown in the STB property data, is present by means of the firmware management server 15 (Step S19). If the firmware tool is present, the management server 13 downloads the firmware tool (Step S20). When the firmware tool is downloaded in Step S20, the management server 13 determines the presence or absence of the action of content purchase in any one of cases in which the STB property has not been recorded on the recovering medium 12 in Step S18 and in which the firmware tool is not present in Step S19 (Step S21). If the action of the purchase is present, the management server 13 reads the corresponding content from the content database through the download server 14 to download the content (Step S22). If the action of the purchase is absent, or the content download has completed in Step S22, the management server 13 ends a series of processing.

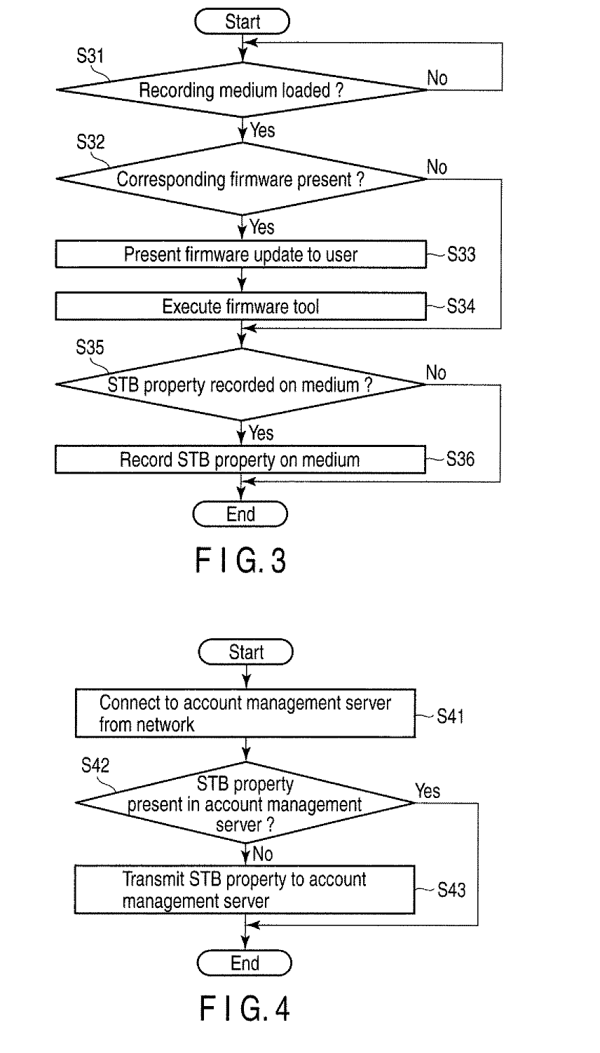

FIG. 3 shows a flowchart depicting a processing procedure of firmware update at the STB terminal 11.

In FIG. 3, when the recording medium 12 is loaded (Step S31), the STB terminal 11 determines if the corresponding firmware tool has been recorded (Step S32). If the firmware tool has been recorded in the recording medium 12, the STB terminal 11 presents the fact to perform firmware update to the user (Step S33), and executes the firmware tool to perform the firmware update (Step S34). If the firmware tool has not been recorded, Steps S33 and S34 are eliminated. After this, it is determined if the STB property of the STB terminal 11 has been recorded on the recording medium 12 (Step S35), if the STB property has not been recorded, the STB terminal 11 records the STB property on the recording medium 12 (Step S36) and ends a series of the processing.

FIG. 4 shows a flowchart illustrating a processing procedure for registering the STB property in the account management server 12 by means of the STB terminal 11.

In FIG. 4, the STB terminal 11 is connected to the management server 13 via the network 17 (Step S41), and the STB terminal 11 determines if the latest STB property has been registered as related data of the user ID acquired through the recording medium 12 (Step S42). If the latest STB property has been registered, the STB terminal 11 ends the processing as it is, and if the latest STB property has not been registered, the STB terminal 11 transmits the latest STB property to the management server 13 to register the latest STB property therein (Step S43), and ends a series of the processing.

That is, the content data providing system adopts a method for transmitting the firmware update tool of the STB terminal through the recording medium 12 such as an SD card. Making the management server 13 manage the user ID on the recording medium 12 associates the account with the recording medium 12. When the recording medium 12 has been loaded in the STB terminal 11, the STB terminal 11 associates the STB property with the management server 13 as account management data.

According to this association, when a medium is loaded in the interface device 16 the next time, if the firmware function update tool has been provided, the update toll is automatically downloaded to the medium 12. If the medium 12 is shared by a plurality of STB terminals 11, all of necessary firmware tools for the STB terminals 11 are downloaded to the medium 12.

As regards the firmware update tool, a tool for updating the firmware itself, a tool for updating the appearance of a wall paper, a tool for installing additional plug-in software, a tool for installing an additional and external application, such as game software, a tool for installing additional content, a tool for updating account data to be loaded in the STB terminal are possible.

The following will describe concrete operations of those tools.

Before starting the download the firmware update tool, the communication interface device 16 reads the user ID, the medium ID, or the product ID of the STB terminal 11 stored in the medium 12, and makes the management server 13 perform account checking by means of the user ID or the medium ID.

If the account has been found and also the STB property including the product ID has not been registered, the STB terminal 11 transmits the STB property which has been already read to the account management server 13. The management server 13 associates the STD property with the account and also confirms if the firmware update associated with the product ID among STB properties has been registered. If the firmware update has been registered, the STB terminal 11 automatically downloads the firmware update toll or firmware data of the STB terminal 11 to the medium 12 when the communication interface device 16 downloads the content.

When the user takes back the medium 12 to load it in the STB terminal 11, the STB terminal 11 confirms the presence or absence of the firmware update tool. If the update tool is present, the STB terminal 11 checks between the version of the update tool and the version of the STB terminal 11, and as the checking result, if it is determined that the update is needed, the STB terminal 11 starts the update. Before starting the update, the STB terminal 11 may display to confirm the user as to the necessity of the start of the update.

After completing the update, the STB terminal 11 reports to the management server 13 to which version the update has been performed. If the STB terminal 11 has not been connected to the network 17, recording the STB property of which the version data has been updated on the medium 12, enables reporting the version data when the medium 12 is connected to the interface device 16 at the next time.

When the account management is desired to be simplified, the STB terminal 11 may confirm whether the firmware update relating to the product ID has been registered for every time.

Therefore, according to the configuration described above, the STB terminal 11 can take in the firmware update tool together with the content and update the firmware with ease by using the recording medium 12 for the content download of the STB terminal 11, by automatically obtaining the necessary firmware update tool in a stage of loading the medium 12 in the interface device 16, and solely by loading the medium 12 in the STB terminal 11.

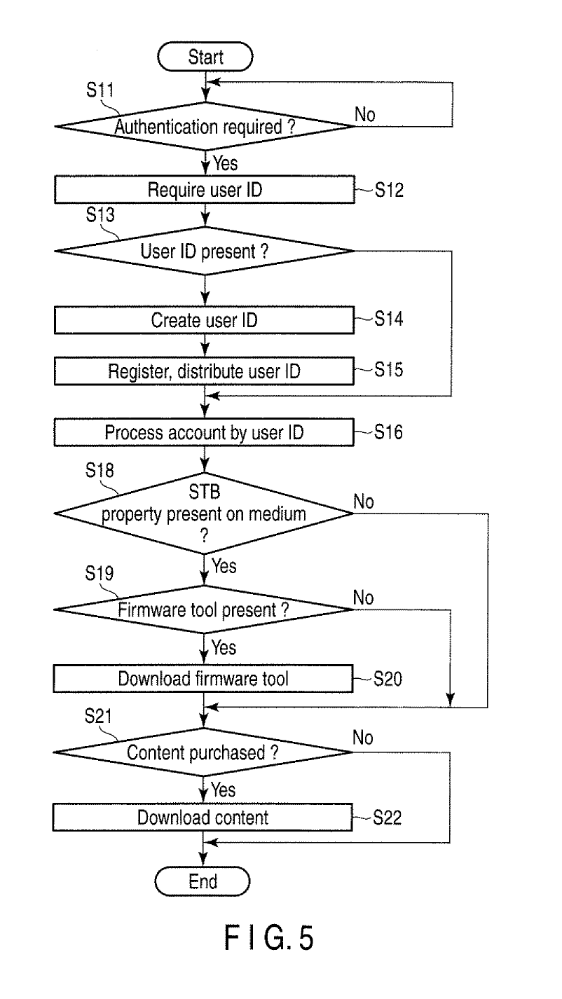

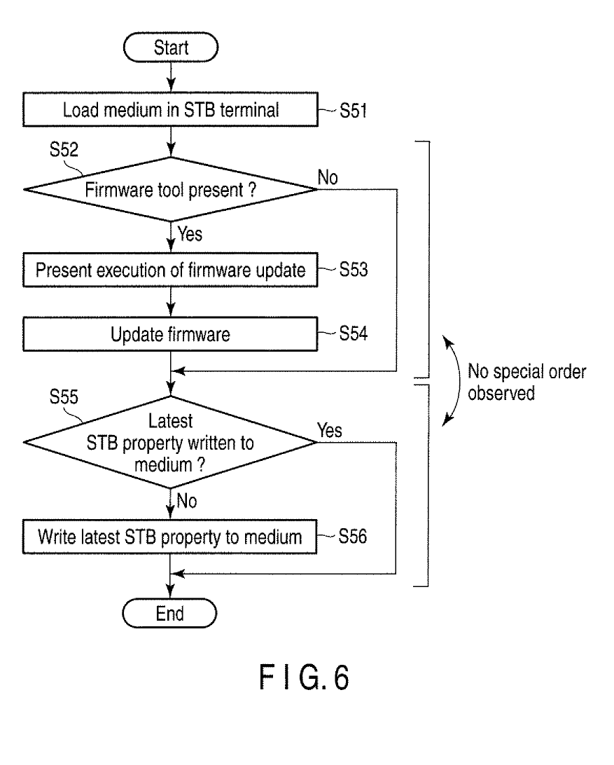

While the foregoing embodiment has been described the case of the situation in which the STB terminal 11 is communicable with the account management server 13 via the network 17, the account management server 13 and the STB terminal 11 may change the processing procedures as shown in FIGS. 5 and 6, respectively in consideration of the case of impossibility of communications.

FIG. 5 shows a flowchart illustrating a processing procedure of the account management server 13 in a case in which the STB terminal 11 cannot communicate with the management server 13. In FIG. 5, the same steps as those of FIG. 2 are designated by the identical symbols, and solely different steps will be described.

In this case the processing procedure of the management server 13 only enables registering the STB property by using the recording medium 12 as a medium. Thus, Step S17 in FIG. 2 becomes useless, and after the processing of Step S16, as shown in FIG. 5, the STB terminal 11 shifts into Step S18 for determining whether the STB property is present in the recording medium 12. If the STB property is present, it is assumed that the STB terminal 11 executes download processing Steps S19 and S20 of the firmware update tool.

Meanwhile, FIG. 6 shows a flowchart illustrating a processing procedure of the STB terminal 11 in a case where the STB terminal 11 cannot communicate with the account management server 13. In the processing by the STB terminal 11, as shown in FIG. 6, in a stage of loading the recording medium 12 (Step S51), it is determined whether the firmware tool has been recorded on the medium 12 (Step S52), and if the firmware tool has been recorded, after presenting the execution of the firmware update to the user (Step S53), the STB terminal 11 executes the firmware tool to perform the update (Step S54). If it is determined that the firmware tool has not been recorded in Step S52, or if the processing of Step S54 has completed, the STB terminal 11 determines if the latest STB property has been written (Step S55). If the STB terminal 11 determines that the latest STB property has not been written, the STB terminal 11 writes the STB property to the medium 12 (Step S56) to end a series of the processing. Any of Steps S52-S54 and Steps S55-S56 may be processed firstly.

As described above, writing the latest STB property to the recording medium 12 for content download by means of the STB terminal 11 enables automatically downloading the necessary firmware tool for downloading the content to the recording medium 12 through the communication interface device 16, and enables automatically executing the update of the firmware when the medium 12 is loaded in the STB terminal 11.

As mentioned above, in the foregoing content data providing system, in a case where the STB terminal 11 and the account management server 13 can be connected through a network, the STB property is uploaded and the recording medium 12 is loaded in the interface device 16 to obtain the user ID and automatically find the account from the user ID. In a case where a new firmware has been registered by means of the STB property, the firmware is downloaded in the medium 12. When the medium 12 is loaded in the STB terminal 11, in a case where a flag of firmware update is set in its own STB property data, the STB terminal 11 automatically executes firmware update. When the update has completed, the STB terminal 11 uploads the STB property to the account management server 13.

Conversely, in a case where the STB terminal 11 and the account management server 13 cannot be connected through a network, when the recording medium 12 is loaded in the STB terminal 11, the STB terminal 11 downloads the STB property to the medium 12. When loading the medium 12 in the interface device 16, the STB terminal 11 uploads the STB property, and in a case where new firmware has been registered by means of the STB property, the STB terminal 11 downloads the firmware to the medium 12. When the medium 12 is loaded in the STB terminal 11, if a flag of firmware update is set in its own STB property data, the STB terminal 11 automatically executes firmware data. When completing update, the STB terminal 11 downloads the STB property to the medium 12 which has been loaded in the STB terminal 11. When connecting the medium 12 to the interface device 16, the STB terminal 11 uploads the STB property.

In any case, the content data providing system can always register the STB property in the account management server 13, automatically download the firmware tool corresponding to the STB terminal 11 through the medium 12, go to a stage of execution of the STB terminal 11, and update the firmware at extreme ease.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content data providing system comprising:
a content data processing terminal configured to read content data from a recording medium with content recorded thereon, and appropriately reproduce the content data for viewing the content; and a content providing device configured to make a registered user of the content data processing terminal download arbitrary content to the recording medium, wherein
the content providing device comprises:
an account management unit which manages user account data of the content data processing terminal to perform authentication processing, and records a terminal property including product identification data of the content data processing terminal as related data of the user account data;
a download management unit which provides content of which the download is required to the recording medium on the basis of an authentication processing result of the account management unit;
a firmware management unit which manages an update tool of firmware of the content data processing terminal for each product; and
an interface unit which receives operations of a user authentication request to the account management unit and a content download request to the download management unit in a loaded state of the recording medium,
the account management unit determines whether the product identification data is included in the related data of the user account data if a user account has been obtained through the authentication processing from the recording medium, determines whether an update tool of firmware of the product is present from the firmware management unit if the product identification data is included, and downloads the firmware tool to the recording medium from the firmware management unit through the interface unit if the update tool is present, and
the content data processing terminal determines whether the update tool has been recorded on the recording medium when the recording medium is loaded, and arbitrarily executes the update tool if the update tool has been recorded.

2. The system of claim 1, wherein:
when the content data processing terminal and the account management unit are in a situation in which they are communicable with each other,
the content data processing terminal registers the user account in the account management unit and also registers the product identification data as the terminal property in the account management unit.

3. The system of claim 1, wherein:
when the content data processing terminal and the account management unit are in a situation in which they are not communicable with each other,
the content data processing terminal registers the terminal property of the content data terminal when the recording medium is loaded in the content data processing terminal, and registers the terminal property in the account management unit when the recording medium is loaded in the interface unit.

4. A content providing apparatus which makes a registered user of a content data processing terminal configured to read content data from a recording medium with content recorded thereon and appropriately reproduce the content data for viewing the content download arbitrary content to the recording medium, comprising:
an account management unit which manages user account data of the content data processing terminal to perform authentication processing, and records a terminal property including product identification data of the content data processing terminal as related data of the user account data;
a download management unit which provides content of which the download is required to the recording medium on the basis of an authentication processing result of the account management unit;
a firmware management unit which manages an update tool of firmware of the content data processing terminal for each product; and
an interface unit which receives operations of a user authentication request to the account management unit and a content download request to the download management unit in a loaded state of the recording medium, wherein
the account management unit determines whether the product identification data is included in the related data of the user account data if a user account has been obtained through the authentication processing from the recording medium, determines whether an update tool of firmware of the product is present from the firmware management unit if the product identification data is included, and downloads the firmware tool to the recording medium from the firmware management unit through the interface unit if the update tool is present.

5. The apparatus of claim 4, wherein:
when the content data processing terminal and the account management unit are in a situation in which they are communicable with each other,
the account management unit registers the product identification data as the terminal property for performing account registration of the content data processing terminal.

6. The apparatus of claim 4, wherein:
when the terminal property of the content data processing terminal has been recorded on the recording medium,
the account management unit updates to register the terminal property when the recording medium is loaded in the interface unit.

7. A content data processing terminal for use in a content data providing system, comprising: a content data processing terminal configured to read content data from a recording medium with content recorded thereon, and appropriately reproduce the content data for viewing the content; and a content providing device configured to make a registered user of the content data processing terminal download arbitrary content to the recording medium, wherein
the content providing device comprises:
an account management unit which manages user account data of the content data processing terminal to perform authentication processing, and records a terminal property including product identification data of the content data processing terminal as related data of the user account data;
a download management unit which provides content of which the download is required to the recording medium on the basis of an authentication processing result of the account management unit;
a firmware management unit which manages an update tool of firmware of the content data processing terminal for each product; and
an interface unit which receives operations of a user authentication request to the account management unit and a content download request to the download management unit in a loaded state of the recording medium, and
the account management unit determines whether the product identification data is included in the related data of the user account data if a user account has been obtained through the authentication processing from the recording medium, determines whether an update tool of firmware of the product is present from the firmware management unit if the product identification data is included, and downloads the firmware tool to the recording medium from the firmware management unit through the interface unit if the update tool is present, and
the content data processing terminal determines whether the update tool has been recorded on the recording medium when the recording medium is loaded, and arbitrarily executes the update tool if the update tool has been recorded.

8. The terminal of claim 7, wherein:
when the terminal and the account management unit are in a situation in which they are communicable with each other,
the terminal registers the user account in the account management unit and also registers the product identification data as the terminal property in the account management unit.

9. The terminal of claim 7, wherein:
when the terminal and the account management unit are in a situation in which they are not communicable with each other,
the terminal registers the terminal property of the terminal is registered in the account management unit when the recording medium is loaded in the interface unit by registering the terminal property when the recording medium is loaded in the interface unit.
